(19) United States
(12) Patent Application Publication
(10) Pub. No.: US 2013/0208063 A1
(43) Pub. Date: Aug. 15, 2013

(54) INK JET PENETRANT, COMPOSITION FOR INK JET RECORDING, AND RECORDING APPARATUS

(71) Applicant: SEIKO EPSON CORPORATION, (US)

(72) Inventors: Tomoyuki Okuyama, Chino-shi (JP); Hiroko Hayashi, Shiojiri-shi (JP); Masahiro Yatake, Shiojiri-shi (JP)

(73) Assignee: SEIKO EPSON CORPORATION, Tokyo (JP)

(21) Appl. No.: 13/762,437

(22) Filed: Feb. 8, 2013

(30) Foreign Application Priority Data
Feb. 9, 2012 (JP) 2012-025957

(51) Int. Cl. C09D 7/12

(52) U.S. Cl. CPC C09D 7/1233
USPC 347/100; 106/31.13; 549/554

(57) ABSTRACT

An ink jet penetrant contains a compound represented by general formula (1), and this compound is obtained by a block polymerization process for sequentially polymerizing an alcohol represented by general formula (2) with propylene oxide and then with ethylene oxide. The amount of this alcohol in the penetrant is 1% by mass or less.

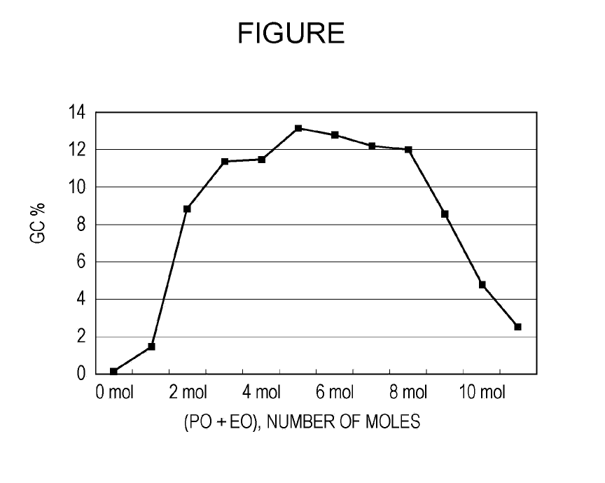

CₓH₂ₓ₊₁—O—(PO)_{y}-(EO)_{z}—H (1)
(where x denotes an integer of 5 to 10, y an integer of 0 to 7, z an integer of 3 to 10, PO a propylene oxide group, and EO an ethylene oxide group)

CₓH₂ₓ₊₁—OH (2)
(where x denotes an integer of 5 to 10)

Priority is claimed under 35 U.S.C. §119 to Japanese Application No. 2012-025957 filed on Feb. 9 2012, is hereby incorporated by reference in its entirety.

### BACKGROUND

1. Technical Field

The present invention relates to an ink jet penetrant, an ink composition for ink jet recording, and a recording apparatus.

2. Related Art

Ink jet recording, a recording method in which an ink jet recording head discharges very small ink droplets through its nozzles and thereby records an image or characters on a recording medium such as plain paper or glossy paper, has been in widespread use in recent years. Plain paper (e.g., copy paper and uncoated printing paper) is not expensive and is easily available and thus it is desired that ink jet recording should rapidly produce high-quality prints on this type of recording medium. However, the use of an aqueous ink in ink jet recording on plain paper poses serious problems of curling and cockling observed in the finished prints. This combination of ink jet recording and an aqueous ink is also disadvantageous in printing on single-purpose glossy paper aiming at photographic image quality because the finished images tend to be poor in graininess, gloss, and rubfastness.

A proposed solution to these problems is to add a 1,2-alkanediol, a glycol ether, or any other suitable water-soluble organic solvent to the aqueous ink (JP-A-2007-153975). This technique offers effective prevention of curling in printing on plain paper and also allows the nozzles of the recording head to discharge satellite dots together with the main dot. The images recorded on single-purpose glossy paper by this technique therefore have good graininess, gloss, and rubfastness.

Incidentally, there has recently been public concern about the effects of volatile organic compounds (VOCs) on human health, and various measures have been taken to regulate the emissions of VOCs. VOCs refer to a class of organic compounds that are volatile and turn into a gaseous form in the air and also include several known additives for aqueous inks, such as 1,2-hexanediol and triethylene glycol monobutyl ether. The development of materials that can replace these water-soluble organic solvents is in demand. However, it has been very difficult to produce an aqueous ink with reduced total VOC emissions and equivalent performance compared to the aqueous inks described in JP-A-2007-153975.

The aqueous inks described in JP-A-2007-153975, which contain a 1,2-alkanediol, a glycol ether, or a similar organic solvent, also have problems; these inks can be harmful to the materials of the ink jet head used therewith and can cause quality alterations, deformation, and other damages to them. Long-term operation with such an ink may affect the reliability of the ink jet head and make the head no longer able to record good-quality images.

### SUMMARY

An aspect of the invention is an ink jet penetrant that reduces the total VOC emissions and allows for recording of good-quality images on plain paper and single-purpose glossy paper. Another aspect is an ink composition for ink jet recording containing this penetrant.

Yet another aspect of the invention is an ink composition for ink jet recording that can be used for long periods of time without affecting the ink jet recording head used therewith, and a different aspect is a recording apparatus provided with this ink composition.

The following are some illustrative aspects or applications of the invention.

### Application 1

An aspect of the invention is an ink jet penetrant. This ink jet penetrant contains a compound represented by general formula (1), and this compound is obtained by a block polymerization process for sequentially polymerizing an alcohol represented by general formula (2) with propylene oxide and then with ethylene oxide. The amount of this alcohol in the penetrant is 1% by mass or less.

CₓH₂ₓ₊₁O—(PO)_{y}-(EO)_{z}—H (1)

(where x denotes an integer of 5 to 10, y an integer of 0 to 7, z an integer of 3 to 10, PO a propylene oxide group, and EO an ethylene oxide group)

CₓH₂ₓ₊₁—OH (2)

(where x denotes an integer of 5 to 10)

Adding the ink jet penetrant according to Application 1 to an ink composition makes the ink composition easier to penetrate into plain paper and improves the gloss of the images recorded on single-purpose glossy paper using the ink composition, with no need for adding known additives for aqueous inks such as 1,2-hexanediol or triethylene glycol monobutyl ether. The ink jet penetrant according to Application 1 is not a volatile organic compound (VOC), and adding it to an ink composition significantly reduces the total VOC emissions of the ink composition. Furthermore, the ink jet penetrant according to Application 1 is not harmful to materials for ink jet heads. Having no potential to cause quality alterations, deformation, or other damages to the materials of the ink jet head used therewith, it can be used for long periods of time without affecting the reliability of the ink jet head.

### Application 2

In Application 1, the block polymerization process can be carried out in the presence of a basic catalyst.

### Application 3

Another aspect of the invention is an ink composition for ink jet recording. This ink composition contains an ink jet penetrant, and this penetrant contains a compound represented by general formula (1). This compound is obtained by a block polymerization process for sequentially polymerizing an alcohol represented by general formula (2) with propylene oxide and then with ethylene oxide. The amount of this alcohol in the ink composition is 0.5% by mass or less.

CₓH₂ₓ₊₁—O—(PO)_{y}-(EO)_{z}—H (1)

(where x denotes an integer of 5 to 10, y an integer of 0 to 7, z an integer of 3 to 10, PO a propylene oxide group, and EO an ethylene oxide group)

CₓH₂ₓ₊₁—OH (2)

(where x denotes an integer of 5 to 10)

### Application 4

The amount of the ink jet penetrant contained in the ink composition for ink jet recording according to Application 3 can be in the range of 0.5% by mass to 5% by mass, both inclusive.

### Application 5

The ink composition for ink jet recording according to Application 3 or 4 can further contain 0.1% by mass or less of a volatile organic solvent with a normal boiling point of 240° C. or less.

### Application 6

The ink composition for ink jet recording according to any one of Applications 3 to 5 can further contain an anionic surfactant.

### Application 7

The clouding point of the ink composition for ink jet recording according to any one of Applications 3 to 6 can be 50° C. or more as measured in the absence of any pigment.

### Application 8

The ink composition for ink jet recording according to any one of Applications 3 to 7 can be used with an ink jet recording apparatus having an ink jet head made of at least one selected from an epoxy adhesive agent, modified polyphenylene ether, and an elastomer.

### Application 9

Yet another aspect of the invention is a recording apparatus. This recording apparatus is provided with the ink composition for ink jet recording according to any one of Applications 3 to 8.

### Application 10

The total hourly VOC emissions of the recording apparatus according to Application 9 can be less than 5 mg/h.

### BRIEF DESCRIPTION OF THE DRAWING

The invention will be described with reference to the accompanying FIGURE.

FIGURE is a graph showing the molecular weight distribution of ink jet penetrant (b) used in an example of the invention.

### DESCRIPTION OF EXEMPLARY EMBODIMENTS

The following describes preferred embodiments of the invention. These embodiments are for illustrative purposes only and should not be construed as limiting any aspect of the invention. The invention includes all modifications that can be implemented without departing from the gist thereof.

### 1. INK JET PENETRANT

The ink jet penetrant according to an embodiment of the invention contains a compound represented by general formula (1), and this compound is obtained by a block polymerization process for sequentially polymerizing an alcohol represented by general formula (2) with propylene oxide and then with ethylene oxide. The amount of this alcohol in the penetrant is 1% by mass or less.

CₓH₂ₓ₊₁—O—(PO)_{y}-(EO)_{z}—H (1)

(where x denotes an integer of 5 to 10, y an integer of 0 to 7, z an integer of 3 to 10, PO a propylene oxide group, and EO an ethylene oxide group)

CₓH₂ₓ₊₁—OH (2)

(where x denotes an integer of 5 to 10)

In general formula (1), PO denotes a propylene oxide group (—CH₂CH₂CH₂O— or —CH(CH₃)CH₂O—), and EO denotes an ethylene oxide group (—CH₂CH₂O—). A block of PO groups and a block of EO groups exist in the compound of formula (1) and are arranged in the order specified in formula (1).

The integer x in general formula (1) is in the range of 5 to 10, preferably 6 to 10, more preferably 6 to 9, and particularly preferably 8 or 9. An x falling below this range often leads to a reduced effect of the penetrant on the improvement of ink penetration into plain paper. However, an x exceeding this range leads to an increased viscosity of the penetrant and thereby limits the amount of the penetrant that can be added to an ink composition for ink jet recording. This is because an ink composition for ink jet recording is difficult to discharge from an ink jet head when it is too viscous. Such a large x thus can also lead to a reduced effect of the penetrant in making the ink composition for ink jet recording containing it easier to penetrate into plain paper.

The hydrocarbon group CₓH₂ₓ₊₁— in general formulae (1) and (2) can be a linear or branched chain. Preferably, it is a branched chain. The use of a branched hydrocarbon group has several advantages: the boiling point of the compound of formula (1) is increased, often to a level high enough to prevent the compound from behaving as a volatile organic compound (VOC), and the penetrant provides the ink composition for ink jet recording containing it with good penetrating properties. The images recorded using this ink composition will be of high quality.

The compound of formula (1) is synthesized from an alcohol of formula (2) as starting material and is prepared by sequentially adding a predetermined amount in moles of propylene oxide and a predetermined amount in moles of ethylene oxide in the presence of a basic catalyst to form a propylene oxide block and then an ethylene oxide block. This means that in general formula (1), the integers y and z are derived from the charge-in amounts of propylene oxide and ethylene oxide in moles, respectively. The resulting material is a mixture containing the compound of formula (1), where y and z are the numbers derived from the charge-in amounts of the oxides in moles, and therefore having a molecular weight distribution.

Examples of basic catalysts that can be used include sodium hydroxide and potassium hydroxide.

Preferably, the obtained mixture is subjected to distillation under reduced pressure to remove the alcohol of formula (2) (hereinafter also referred to as raw material alcohol). This distillation process is not required when all of the raw material alcohol is consumed in the reaction. Usually, however, some of the raw material alcohol is left unreacted and thus it is desired to remove this residue by distilling the mixture under reduced pressure. The ink compositions disclosed in U.S. Pat. No. 6,839,612, a publication in the related art, for example, are not preferred embodiments of the present invention because they are produced with no treatment to remove the raw material alcohol. This embodiment of the present invention can yield a mixture containing the raw material alcohol in an amount as low as 1% by mass or less when carried out in the way described above. This mixture, in which the compound of formula (1) is not a volatile organic compound (VOC), is preferred because it significantly reduces the VOC content of the ink composition containing it. From the viewpoint of the reduction of the VOC content, the amount of the raw material alcohol in the mixture is preferably 0.5% by mass or less, more preferably 0.1% by mass or less, particularly preferably equal to 0.01% by mass, and the most preferably equal to 0% by mass (no raw material alcohol left).

The integer y in general formula (1), which is derived from the charge-in amount of propylene oxide in moles, is in the range of 0 to 7, preferably 0 to 5, and more preferably 0 to 2.

The integer z in general formula (1), which is derived from the charge-in amount of ethylene oxide in moles, is in the range of 3 to 10, preferably 3 to 7, and more preferably 3 to 5.

### 2. INK COMPOSITION FOR INK JET RECORDING

The following details the individual components of the ink composition for ink jet recording according to this embodiment.

### 2.1. Ink Jet Penetrant

The ink composition for ink jet recording according to an embodiment of the invention contains an ink jet penetrant, and this ink jet penetrant contains a compound represented by general formula (1). A single ink jet penetrant or a mixture of two or more kinds of ink jet penetrants can be used.

The ink jet penetrant or penetrants give the ink composition good penetrating properties in printing on plain paper and allow the ink composition to produce images with good graininess, gloss, and rubfastness in printing on single-purpose glossy paper, with no need for adding a water-soluble organic solvent that could be added to known aqueous inks, such as a 1,2-alkanediol or a glycol ether. The use of the ink jet penetrant or penetrants also means eliminating potential volatile organic compounds (VOCs) from the ink composition for ink jet recording and thus significantly reducing the total VOC emissions of the ink composition. A combination of two or more compounds of formula (1) with an x in the range of 6 to 9 is particularly effective for the gloss of images printed on single-purpose glossy paper.

From the viewpoint of the reduction of the VOC content, the amount of the raw material alcohol in the ink composition for ink jet recording is preferably 0.5% by mass or less, more preferably 0.1% by mass or less, particularly preferably equal to 0.01% by mass, and the most preferably equal to 0% by mass (no raw material alcohol left).

The ink jet penetrants described above are non-corrosive to materials for ink jet heads (e.g., epoxy adhesive agents, modified polyphenylene ether, and elastomers) and do not alter the quality of them or deform them. This is an advantage to the ink composition for ink jet recording according to this embodiment as it can be used for long periods of time without affecting the reliability of the ink jet head used therewith.

The amount of the ink jet penetrant or penetrants is preferably in the range of 0.5% by mass to 5% by mass, both inclusive, and more preferably 0.7% by mass to 2% by mass, both inclusive. The ink jet penetrant or penetrants give the ink composition good penetrating properties in printing on plain paper and allow the ink composition to produce images with satisfactory quality on single-purpose glossy paper when their content is 0.5% by mass or more, and they give an appropriate viscosity to the ink composition when their content is 5% by mass or less.

### 2.2. Anionic Surfactant

The ink composition for ink jet recording according to this embodiment may further contain an anionic surfactant in any amount. Preferably the amount of the anionic surfactant is in the range of 0.01% by mass to 0.5% by mass, both inclusive, and more preferably 0.1% by mass to 0.2% by mass, both inclusive. The ink composition for ink jet recording according to this embodiment, which contains at least one ink jet penetrant described above, suddenly becomes turbid when it is heated beyond its clouding point because the solubility of the ink jet penetrant(s) falls and the penetrant(s) can no longer form micelles and separates out of the aqueous phase. This appears to be because at an increased temperature the hydrogen bonds between polyether chains and water molecules are broken, causing a sudden drop of solubility. Adding an anionic surfactant in an amount in the above range improves the solubility of the ink jet penetrant(s) in water and thereby raises the clouding point of the ink composition. This makes the ink composition for ink jet recording according to this embodiment able to be used in a wider temperature range and improves the transport and storage stability of it.

Examples of anionic surfactants that can be used include alkyl ether sulfate salts, alkyl sulfuric acid salts, alkyl phosphoric acid salts, alkyl phosphate salts, and polyoxyethylene alkyl ether sulfuric acid salts. Examples of counter cations used with them include lithium, sodium, and potassium ions, mono-, di-, and trialkyl ammonium ions, and mono-, di- and triethanol ammonium ions.

### 2.3. Coloring Material

The ink composition for ink jet recording according to this embodiment may further contain coloring material. The coloring material may be a dye or a pigment.

Examples of dyes that can be used include those that can be used in ink jet recording, such as direct dyes, acid dyes, food dyes, basic dyes, reactive dyes, disperse dyes, vat dyes, soluble vat dyes, and reactive disperse dyes.

All kinds of pigments can also be used, including inorganic and organic ones. Examples of inorganic pigments for black ink include titanium oxide and iron oxide as well as the pigment Carbon Black (C.I. Pigment Black 7) and other forms of carbon black such as furnace black, lamp black, acetylene black, and channel black. Examples of organic pigments for black ink include black organic pigments such as aniline black (C.I. Pigment Black 1).

Examples of pigments for yellow ink include the following: C.I. Pigment Yellow 1 (Hansa Yellow), 3 (Hansa Yellow 10G), 12, 13, 14, 17, 24 (Flavanthrone Yellow), 34, 35, 37, 53, 55, 65, 73, 74, 81, 83, 93, 94, 95, 97, 98, 99, 108 (Anthrapyrimidine Yellow), 109, 110, 113, 117 (a copper complex pigment), 120, 128, 133 (quinophthalone), 138, 139 (isoindolinone), 147, 151, 153 (a nickel complex pigment), 154, 155, 167, 172, 180, 185, and 213 and the pigments represented by chemical formula (1) of International Publication No. WO 2011/027842.

Examples of pigments for red ink include the following: C.I. Pigment Red 1 (Para Red), 2, 3 (Toluidine Red), 5 (ITR Red), 7, 9, 10, 11, 12, 17, 30, 31, 38 (Pyrazolone Red), 42, 88 (Thioindigo), 112 (a naphthol AS pigment), 114 (a naphthol AS pigment), 122 (dimethyl quinacridone), 123, 144, 149, 150, 166, 168 (Anthanthrone Orange), 170 (a naphthol AS pigment), 171, 175, 176, 177, 178, 179 (Perylene Maroon), 185, 187, 209 (dichloroquinacridone), 219, 224 (a perylene pigment), and 245 (a naphthol AS pigment) and C.I. Pigment Violet 19 (quinacridone), 23 (Dioxazine Violet), 32, 33, 36, 38, 43, and 50.

Examples of pigments for cyan ink include the following: C.I. Pigment Blue 15, 15:1, 15:2, 15:3, 15:4, 16 (metal-free phthalocyanine), 18 (Alkali Blue Toner), 25, 60 (Indanthrone Blue), 65 (violanthrone), and 66 (Indigo).

Examples of organic pigments used in color inks other than magenta, cyan, or yellow ink include the following: C.I. Pigment Green 7 (Phthalocyanine Green), 10 (Green Gold), 36, and 37; C.I. Pigment Brown 3, 5, 25, and 26; and C.I. Pigment Orange 1, 2, 5, 7, 13, 14, 15, 16, 34, 36, and 38.

Pigments of any average particle diameter can be used. However, pigments of an average particle diameter of 30 to 120 nm are preferred, pigments of an average particle diameter of 30 to 100 nm are more preferred, and pigments of an average particle diameter of 30 to 80 nm are particularly preferred. An average particle diameter of 30 nm or more often leads to a good color reproduction (OD) on plain paper, and an average particle diameter of 120 nm or less often leads to a high degree of gloss on glossy paper.

When a pigment is used, it may be dispersed in an aqueous medium with a dispersant. Examples of dispersants that can be used include resins based on a styrene-acrylic acid copolymer backbone having a weight-average molecular weight (hereinafter simply referred to as molecular weight or MW) of 1600 to 25000 and an acid value (AV) of 100 to 250. Specific examples include the following, which are all manufactured by Johnson Polymer: JONCRYL 68 (MW: 10000; AV: 195), JONCRYL 680 (MW: 3900; AV: 215), JONCRYL 682 (MW: 1600; AV: 235), JONCRYL 550 (MW: 7500; AV: 200), JONCRYL 555 (MW: 5000; AV: 200), JONCRYL 586 (MW: 3100; AV: 105), JONCRYL 683 (MW: 7300; AV: 150), and B-36 (MW: 6800; AV: 250).

When a pigment is used, it may be a surface-treated carbon black or organic pigment having a functional group on its surface for self-dispersion in aqueous solvents.

In the ink composition for ink jet recording according to this embodiment, any one of the coloring materials mentioned above or a combination of two or more can be used.

Any amount of coloring material can be added. However, the coloring material content is preferably in the range of 0.5 to 30% by mass and more preferably 1.0 to 12% by mass. A coloring material content of 0.5% by mass or more leads to a more appropriate printing density, and a coloring material content of 30% by mass or less leads to more appropriate viscosity characteristics and improved discharge stability of the ink composition.

### 2.4. Water and Other Ingredients

Water is the primary solvent in the ink composition for ink jet recording according to this embodiment. Purified water such as ion-exchanged water, ultrafiltered water, reverse-osmosis-purified water, or distilled water or ultrapure water can be used. Water sterilized by ultraviolet irradiation, treatment with hydrogen peroxide, or any other appropriate technique is preferred as it allows the ink composition to be stored for a long term with little mold or bacterial growth.

The ink composition for ink jet recording according to this embodiment may further contain a water-soluble glycol. Water-soluble glycols are effective in preventing the ink composition from drying up at the distal end of nozzles. Water-soluble glycols with a normal boiling point exceeding 240° C. are preferred as they do not interfere with the removal of volatile organic compounds (VOCs) from the ink composition. The term normal boiling point, as used herein, denotes the boiling point of a liquid at 1 atm.

Specific examples of appropriate water-soluble glycols include diethylene glycol, triethylene glycol, tripropylene glycol, tetraethylene glycol, polyethylene glycol with a molecular weight or 600 or more, trimethylolpropane, 1,5-pentanediol, 1,6-hexanediol, glycerol, meso-erythritol, and pentaerythritol. Any single water-soluble glycol or a combination of two or more water-soluble glycols can be used. The water-soluble glycol content is preferably in the range of 1 to 30% by mass and more preferably 3 to 15% by mass.

The ink composition for ink jet recording according to this embodiment may further contain a saccharide. Adding a saccharide avoids clogging, or prevents the ink composition from drying up at the end of the ink jet head and blocking the nozzles.

Examples of preferred saccharides include monosaccharides and polysaccharides, such as glucose, mannose, fructose, ribose, xylose, arabinose, lactose, galactose, aldonic acid, glucitose, maltose, cellobiose, sucrose, trehalose, and maltotriose as well as alginic acid and its salts, cyclodextrins, and celluloses. The saccharide content is preferably in the range of 0.05 to 30% by mass.

The ink composition for ink jet recording according to this embodiment may further contain a preservative and an antimold. Examples include sodium benzoate, sodium pentachlorophenol, sodium 2-pyridinethiol-1-oxide, sodium sorbate, sodium dehydroacetate, and 1,2-benzisothiazolin-3-one (ICI PROXEL CRL, PROXEL BDN, PROXEL GXL, PROXEL XL-2, and PROXEL TN).

The ink composition for ink jet recording according to this embodiment may contain a pH-adjusting agent, a dissolution aid, and/or an antioxidant if necessary. Examples include the following: amines such as diethanolamine, triethanolamine, propanolamine, and morpholine and their conversion products; inorganic salts such as potassium hydroxide, sodium hydroxide, and lithium hydroxide; ammonium hydroxide and quaternary ammonium hydroxides (e.g., tetramethylammonium hydroxide); carbonates such as potassium carbonate, sodium carbonate, and lithium carbonate and phosphates; N-methyl-2-pyrrolidone; urea and related compounds such as thiourea and tetramethylurea; allophanate and related compounds such as methyl allophanate; biuret and related compounds such as dimethyl biuret and tetramethyl biuret; and L-ascorbic acid and its salts.

### 2.5. Physical Properties

### 2.5.1. Volatile Organic Compound (VOC) Emissions

The ink composition for ink jet recording according to this embodiment contains 0.1% by mass or less of volatile organic solvents with a normal boiling point of 240° C. or less. The volatile organic solvent content is preferably 0.05% by mass or less, more preferably 0.01% by mass or less, and particularly preferably equal to 0% by mass.

This ink composition, which contains at least one ink jet penetrant described above, has good penetrating properties in printing on plain paper and can produce images with good graininess, gloss, and rubfastness in printing on single-purpose glossy paper, without needing a water-soluble organic solvent that could be added to known aqueous inks, such as a 1,2-alkanediol or a glycol ether. Potential volatile organic compounds (VOCs) are eliminated from the ink composition for ink jet recording, and the total VOC emissions of the ink composition are significantly reduced. Therefore the ink composition for ink jet recording according to this embodiment, when used with a recording apparatus, contributes to reduced total VOC emissions from it. The total hourly VOC emissions of a recording apparatus used with this ink composition for ink jet recording are preferably less than 5 mg/h and more preferably less than 1 mg/h.

### 2.5.2. Clouding Point

The clouding point of the ink composition for ink jet recording according to this embodiment is preferably 50° C. or more and more preferably 60° C. or more. The ink composition can be used in a wider temperature range and its transport and storage stability are improved when its clouding point is 50° C. or more.

The clouding point of an ink composition for ink jet recording can be measured in the following way. After removal of the pigment solid content, 30 g of the composition and a stirring bar are put into a 100-mL sampling vial. The composition is stirred and heated with a hot stirrer. The temperature at which the composition becomes turbid is the clouding point.

### 2.5.3. Viscosity

The viscosity of the ink composition for ink jet recording according to this embodiment at 20° C. is preferably in the range of 2 mPa·s to 15 mPa·s, both inclusive, and more preferably in the range of 2 mPa·s to 10 mPa·s. A viscosity in these ranges ensures that the ink composition can be discharged in a stable manner. The viscosity of an ink composition can be measured in Physica MCR-300 rheometer by increasing the shear rate from 10 to 1000 at 20° C. and reading the viscosity at a shear rate of 200.

### 2.6. Applications

The ink composition for ink jet recording according to this embodiment can be used in ink jet recording, i.e., a recording method in which very small droplets of the ink composition are discharged onto a recording medium and thereby records are made. The recording medium may be heated or unheated. Heating the recording medium makes the ink composition droplets adhering thereto quicker to dry in some cases. Examples of the mechanism for discharging an ink composition in the form of droplets include the piezoelectric mechanism and the bubble mechanism. The piezoelectric mechanism uses piezoelectric elements to convert electric signals into mechanical ones and thereby makes the ink jet head intermittently discharge the ink contained therein onto a recording medium to record characters or symbols on the surface of it. The bubble mechanism uses bubbles, which are generated by rapid heating of the ink in the ink jet head at the point very close to the nozzles, to inflate the ink and thereby makes the ink jet head intermittently discharge the ink and record characters or symbols on the surface of a recording medium. The ink composition for ink jet recording according to this embodiment is particularly suitable for use in the piezoelectric mechanism.

An ink jet head for the piezoelectric mechanism is composed of an actuator unit, a nozzle unit, and a case head. The actuator unit is bonded to the nozzle unit using an epoxy adhesive agent, and the obtained component is bonded to the case head, which is made of injection-molded resin. The actuator unit has a communication plate having communication ports, a plate having pressure chambers, a vibrating plate, and actuators. The communication and pressure chamber plates are made of modified polyphenylene ether or a similar material. The nozzle unit is made of an elastomer or a similar material.

The known aqueous ink compositions, which contain a 1,2-alkanediol, a glycol ether, or a similar organic solvent, can be harmful to the materials of the ink jet head used therewith (e.g., modified polyphenylene ether, elastomers, and epoxy adhesive agents) and can cause quality alterations, deformation, and other damages to the materials. Long-term operation with such an ink may affect the reliability of the ink jet head and make the head no longer able to record good-quality images. The ink composition for ink jet recording according to this embodiment is much less harmful to modified polyphenylene ether, epoxy adhesive agents, and elastomers and thus can be used for long periods of time without affecting the reliability of the ink jet head used therewith.

### 3. EXAMPLES

The following illustrates embodiments of the invention by providing examples and comparative examples. These examples should not be construed as limiting any aspect of the invention.

### 3.1. Synthesis of Ink Jet Penetrants

Ink jet penetrants (hereinafter also simply referred to as penetrants) (a) to (j) used in these examples were compounds represented by general formula (1) and synthesized from raw material alcohols represented by general formula (2). The values x, y, and z in general formulae (1) and (2) were as shown in Table 1. The following illustrates the synthesis of these penetrants.

CₓH₂ₓ₊₁—O—(PO)_{y}-(EO)_{z}—H (1)

CₓH₂ₓ₊₁—OH (2)

TABLE 1

| | x | y | z | Raw material alcohol content |
|---|---|---|---|---|
| Ink jet penetrant (a) | 5 | 1 | 3 | ≦1% |
| Ink jet penetrant (b) | 6 | 2 | 5 | ≦1% |
| Ink jet penetrant (c) | 8 | 0 | 2 | ≦1% |
| Ink jet penetrant (d) | 8 | 2 | 5 | ≦1% |
| Ink jet penetrant (e) | 9 | 7 | 4 | ≦1% |
| Ink jet penetrant (f) | 10 | 2 | 10 | ≦1% |
| Ink jet penetrant (g) | 6 | 2 | 5 | 1.5% |
| Ink jet penetrant (h) | 6 | 2 | 5 | 3.0% |
| Ink jet penetrant (i) | 4 | 0 | 3 | TEGmBE mfd. by Tokyo |
| | | | | Chemical Industry |
| Ink jet penetrant (j) | 11 | 5 | 10 | ≦1% |

### 3.1.1. Synthesis of Ink Jet Penetrant (b)

Penetrant (b) was synthesized from 4-methyl-2-pentanol as starting material and prepared by sequentially adding 2 mole equivalents of propylene oxide and 5 mole equivalents of ethylene oxide in the presence of a basic catalyst (potassium hydroxide) to form a propylene oxide block and then an ethylene oxide block. The resulting material was a mixture containing the compound of formula (1), where y and z were the numbers derived from the charge-in amounts of the oxides in moles, and therefore having a molecular weight distribution. The obtained mixture was then distilled under reduced pressure to remove the raw material alcohol, i.e., 4-methyl-2-pentanol. In this way penetrant (b) was obtained with a 4-methyl-2-pentanol content of 1% by mass or less. The molecular weight distribution of penetrant (b) was as shown in FIGURE, where the horizontal axis represents the total number of moles of ethylene oxide and propylene oxide and the vertical axis the percentage with the total quantity of the ink jet penetrant as 100%. In general, the molecular weight distribution of a mixture can be determined by GC-MS. As for penetrant (b), its molecular weight distribution was determined in the following way. A sample was heated to 300° C. using a pyrolyzer, the volatile components released from the sample were collected using liquid nitrogen, and the collected fraction was analyzed by GC-MS under the conditions below. The residue was then thermally decomposed by heating to 550° C. with the pyrolyzer, and the decomposition product was analyzed by GC-MS under the same conditions. The fragment ion peaks on the mass spectra of both the volatile component and the decomposition product were used to identify the structure of penetrant (b).

System: An Agilent GC-MS system, 6890 gas chromatograph and 5975 mass spectrometer

Column: Frontier Laboratories UA-5 (trade name), 30 m in length, 250 μm in inner diameter, and 0.25 μm in membrane thickness

He flow rate: 1 mL/min

### 3.1.2. Synthesis of Ink Jet Penetrants (a) and (c) to (j)

Penetrants (a) and (c) to (j) were synthesized in the same way as penetrant (b) except that the charge-in amounts of the raw material alcohol, propylene oxide, and ethylene oxide in moles were changed as shown in Table 1. Penetrants (g) and (h) were not subjected to distillation under reduced pressure to remove the raw material alcohol.

### 3.2. Preparation of Ink Compositions

### 3.2.1. Preparation of Pigment Dispersion

The ink compositions used in these examples contained a water-insoluble pigment (C.I. Pigment Blue 15:4, a cyan pigment) as coloring material. This pigment was dispersed with a resin dispersant, and the resulting pigment dispersion was used to prepare the ink compositions.

The pigment dispersion was prepared in the following way. First, 1.5 parts by mass of 30% aqueous ammonia (a neutralizing agent) was dissolved in 79 parts by mass of ion-exchanged water, and 6 parts by mass of a styrene-acrylic acid copolymer (MW: 1600; AV: 150) as the resin dispersant was dissolved in this aqueous solution. Then 15 parts by mass of the pigment (C.I. Pigment Blue 15:4) was added and dispersed with zirconia beads in a ball mill for 10 hours. The resulting dispersion was centrifuged and filtered to remove impurities such as coarse particles and debris. The pigment content was adjusted to 15% by mass.

### 3.2.2. Preparation of Ink Compositions

Cyan ink compositions with different formulae were prepared using this pigment dispersion in accordance with the formulae in Tables 2 and 3. Each ink composition was prepared by putting the ingredients listed in Table 2 or 3 into a vessel, mixing and stirring them with a magnetic stirrer for 2 hours, and then filtering the resulting liquid through a 5-μm membrane filter to remove impurities such as debris and coarse particles. The values in Tables 2 and 3 are all in the unit of % by mass, and ion-exchanged water was added to make the total amount of the ink composition 100% by mass.

TABLE 2

| Ingredient | Ex. 1 | Ex. 2 | Ex. 3 | Ex. 4 | Ex. 5 | Ex. 6 | Ex. 7 | Ex. 8 | Ex. 9 | Ex. 10 |
|---|---|---|---|---|---|---|---|---|---|---|
| Pigment | 3.00 | 3.00 | 3.00 | 3.00 | 3.00 | 3.00 | 3.00 | 3.00 | 3.00 | 3.00 |
| (C.I. Pigment Blue 15:4) | | | | | | | | | | |
| Styrene-acrylic acid | 1.20 | 1.20 | 1.20 | 1.20 | 1.20 | 1.20 | 1.20 | 1.20 | 1.20 | 1.20 |
| copolymer | | | | | | | | | | |
| Penetrant (a) | 0.50 | | | | | | | | | |
| Penetrant (b) | | 2.00 | 2.00 | 2.00 | 2.00 | 2.00 | 2.00 | | | |
| Penetrant (c) | | | | | | 0.50 | | | | 0.50 |
| Penetrant (d) | 2.00 | | | | | | | 2.00 | 2.00 | |
| Penetrant (e) | | | | | | | 0.50 | | 0.50 | |
| Penetrant (f) | | | | | | | | | | 2.00 |
| Anionic surfactant A | 0.10 | 0.05 | 0.10 | | | 0.10 | 0.10 | 0.10 | 0.10 | 0.10 |
| Anionic surfactant B | | | | 0.05 | 0.10 | | | | | |
| Glycerol | 12.00 | 11.00 | 11.00 | 11.00 | 11.00 | 11.00 | 14.00 | 10.00 | 10.00 | 9.00 |
| TEG | 4.00 | | | | | | 2.00 | 2.00 | 2.00 | 1.00 |
| TMP | 4.00 | 1.00 | 1.00 | 1.00 | 1.00 | 1.00 | | 2.00 | | |
| TEA | 1.00 | 1.00 | 1.00 | 1.00 | 1.00 | 1.00 | 1.00 | 1.00 | 1.00 | 1.00 |
| Water | Balance | Balance | Balance | Balance | Balance | Balance | Balance | Balance | Balance | Balance |
| Total amount | 100.00 | 100.00 | 100.00 | 100.00 | 100.00 | 100.00 | 100.00 | 100.00 | 100.00 | 100.00 |

Evaluations

| | | | | | | | | | | |
|---|---|---|---|---|---|---|---|---|---|---|
| Penetration | B | A | A | A | A | A | A | A | A | B |
| Gloss | B | B | B | B | B | A | A | B | A | B |
| Storage stability | A | B | A | B | A | A | A | A | A | A |
| VOC emissions | A | A | A | A | A | A | A | A | A | A |

TABLE 3

| | | | | | | | | | | Comp. | Comp. | Comp. | Comp. | Comp. |
|---|---|---|---|---|---|---|---|---|---|---|---|---|---|---|
| | | | | | | | | | | Ex. | Ex. | Ex. | Ex. | Ex. |
| Ingredient | Ex. 11 | Ex. 12 | Ex. 13 | Ex. 14 | Ex. 15 | Ex. 16 | Ex. 17 | Ex. 18 | Ex. 19 | 1 | 2 | 3 | 4 | 5 |
| Pigment | 3.00 | 3.00 | 3.00 | 3.00 | 3.00 | 3.00 | 3.00 | 3.00 | 3.00 | 3.00 | 3.00 | 3.00 | 3.00 | 3.00 |
| (C.I. Pigment | | | | | | | | | | | | | | |
| Blue 15:4) | | | | | | | | | | | | | | |
| Styrene-acrylic | 1.20 | 1.20 | 1.20 | 1.20 | 1.20 | 1.20 | 1.20 | 1.20 | 1.20 | 1.20 | 1.20 | 1.20 | 1.20 | 1.20 |
| acid | | | | | | | | | | | | | | |
| copolymer | | | | | | | | | | | | | | |
| Penetrant (b) | 2.00 | 2.00 | 2.00 | | | 2.00 | 2.00 | 2.00 | 2.00 | | | | | |
| Penetrant (c) | | | 0.50 | | | | | | | | | | | |
| Penetrant (d) | | | | 2.00 | | | | | | | | | | |
| Penetrant (f) | | | | | 2.00 | | | | | | | | | |
| Penetrant (g) | | | | | | | | | | 2.00 | | | | |
| Penetrant (h) | | | | | | | | | | | 2.00 | | | |
| Penetrant (i) | | | | | | | | | | | | | 2.00 | |
| Penetrant (j) | | | | | | | | | | | | | | 2.00 |
| 1,2-HD | | | | | | | | | | | | 5.00 | | |
| BYK-348 | | | | | | | | | | | | 0.50 | | |
| E1010 | | 0.50 | 0.50 | | | | | | | | | | | |
| Anionic surfac- | | | | | | 0.01 | | 0.50 | | | | | | |
| tant A | | | | | | | | | | | | | | |
| Anionic surfac- | | | | | | | 0.01 | | 0.50 | | | | | |
| tant B | | | | | | | | | | | | | | |
| Glycerol | 10.00 | 11.00 | 11.00 | 10.00 | 9.00 | 10.00 | 10.00 | 10.00 | 10.00 | 10.00 | 10.00 | 9.00 | 10.00 | 10.00 |
| TEG | 2.00 | | | | | 2.00 | 2.00 | 2.00 | 2.00 | 2.00 | 2.00 | | 2.00 | 2.00 |
| TMP | | 1.00 | 1.00 | 1.00 | | | | | | | | | | |
| TEA | 1.00 | 1.00 | 1.00 | 1.00 | 1.00 | 1.00 | 1.00 | 1.00 | 1.00 | 1.00 | 1.00 | 1.00 | 1.00 | 1.00 |
| Water | Balance | Balance | Balance | Balance | Balance | Balance | Balance | Balance | Balance | Balance | Balance | Balance | Balance | Balance |
| Total amount | 100.00 | 100.00 | 100.00 | 100.00 | 100.00 | 100.00 | 100.00 | 100.00 | 100.00 | 100.00 | 100.00 | 100.00 | 100.00 | 100.00 |

Evaluations

| | | | | | | | | | | | | | | |
|---|---|---|---|---|---|---|---|---|---|---|---|---|---|---|
| Penetration | A | A | A | A | A | A | A | B | B | A | A | B | B | C |
| Gloss | B | B | A | A | A | B | B | B | B | B | A | A | C | B |
| Storage | C | C | C | C | C | B | B | A | A | C | C | A | C | C |
| stability | | | | | | | | | | | | | | |
| VOC | A | A | A | A | A | A | A | A | A | C | C | C | C | A |
| emissions | | | | | | | | | | | | | | |

The abbreviations used in Tables 2 and 3 have the following meanings.

Anionic surfactant A: Polyoxyethylene alkyl ether phosphoric acid (PHOSPHANOL RS-610 [trade name], manufactured by TOHO Chemical Industry Co., Ltd.)

Anionic surfactant B: Polyoxyethylene alkyl ether sulfate salt (EMAL 20C [trade name], manufactured by Kao Corporation)

1,2-HD: 1,2-Hexanediol

BYK-348: A silicone surfactant (a polyether-modified siloxane manufactured by BYK Japan KK; “BYK-348” is a trade name)

E1010: An acetylenic diol surfactant (OLFINE E1010 [trade name], manufactured by Nissin Chemical Co., Ltd.)

TEG: Tetraethyleneglycol

TMP: Trimethylolpropane

TEA: Triethanolamine

### 3.3. Evaluation of Ink Compositions

### 3.3.1. Penetration

High-quality plain paper (Seiko Epson KA4250NP [model No.]) was used as recording medium. Each of the ink compositions was loaded into an ink jet printer (Seiko Epson EM-930C [trade name]), and prints were made on the surface of the high-quality plain paper under ordinary temperature and pressure conditions. The printing mode for plain paper was used with default settings. The obtained prints were air-dried and then visually inspected for the degree of bleeding in accordance with the following criteria. Results are summarized in Tables 2 and 3.

A: No bleeding observed. The image was of satisfactory quality.

B: A slight degree of bleeding observed.

C: Whisker-shaped bleeding was observed.

### 3.3.2. Gloss

Single-purpose glossy paper (Seiko Epson PM Shashin Youshi [PM photographic paper; trade name]) was used as recording medium. Each of the ink compositions was loaded into an ink jet printer (Seiko Epson EM-930C [trade name]), and a solid image was printed with a resolution of 720×720 dpi on the surface of the single-purpose glossy paper under ordinary temperature and pressure conditions. The degree of gloss of the recording surface at an incident angle of 60° was measured using a gloss checker (IG-320 [trade name], manufactured by HORIBA, Ltd.). Five measurements on each record were averaged and this average was used to evaluate the gloss of that record. The evaluation criteria were as follows. Results are summarized in Tables 2 and 3.

A: The degree of gloss was ≧60.

B: The degree of gloss was ≧30 to <60.

C: The degree of gloss was <30.

### 3.3.3. Storage Stability

The storage stability of the ink compositions in Tables 2 and 3 was evaluated by measuring the clouding point of the compositions in the absence of pigment solid content. The clouding point of the test compositions was measured in the following way. After removal of the pigment solid content, 30 g of the composition and a stirring bar were put into a 100-mL sampling vial. The composition was then stirred and heated with a hot stirrer. The temperature at which the composition became turbid was taken as the clouding point. The evaluation criteria were as follows. Results are summarized in Tables 2 and 3.

A: The clouding point was ≧60° C.

B: The clouding point was ≧50° C. to <60° C.

C: The clouding point was <50° C.

### 3.3.4. Volatile Organic Compound (VOC) Emissions

Each of the ink compositions was loaded into an ink jet printer (Seiko Epson PX-H6000 [trade name]) and the ink jet printer was then stored and sealed in a stainless-steel container. The air in the container was circulated using a pump for 10 minutes, while the circulating air was allowed to pass through an adsorption column so that volatile organic compounds (VOCs) could be collected in the adsorption column. The absorption column was then heated to desorb the VOCs, followed by a gas chromatographic assay to determine the VOC emissions. The evaluation criteria were based on the hourly emissions as presented below. Results are summarized in Tables 2 and 3.

A: The total VOC emissions of the ink composition (recording apparatus) were <1 mg/h.

B: The total VOC emissions of the ink composition (recording apparatus) were ≧1 mg/h to <5 mg/h.

C: The total VOC emissions of the ink composition (recording apparatus) were ≧5 mg/h.

### 3.4. Evaluation Results

Examples 1 to 19: The ink compositions prepared using penetrants containing a compound represented by general formula (1) were excellent in terms of penetration into plain paper and the gloss of images recorded on single-purpose glossy paper. The VOC emissions of the ink compositions were very low.

Examples 1 to 10 and 16 to 19: The use of a penetrant(s) containing a compound represented by general formula (1) in combination with an anionic surfactant led to a raised clouding point and improved storage stability of the ink composition.

Comparative Examples 1 and 2: The use of a penetrant containing more than 1% of the raw material alcohol led to increased VOC emissions.

Comparative Example 3: The VOC emissions of this known ink composition were clearly high.

Comparative Example 4: As the x in general formula (1) was 4, this ink composition had relatively low penetration properties and was also inferior in terms of gloss, storage stability, and VOC emissions.

Comparative Example 5: As the x in general formula (1) was 11, this ink composition had significantly low penetration properties and was also inferior in terms of storage stability.

The invention is never limited to the embodiment described above, and various modifications are allowed. For example, the invention includes constitutions that are substantially the same as the embodiment described above (e.g., ones that have the same function, are based on the same method, and provide the same results as the embodiment, or ones for the same purposes and advantages as the embodiment). Furthermore, the invention includes constitutions obtained by changing any nonessential part or parts of the embodiment described above. Moreover, the invention includes constitutions having the same operations and offering the same advantages as the embodiment described above and constitutions that can achieve the same purposes as the embodiment described above. Additionally, the invention includes constitutions obtained by adding any known technology or technologies to the embodiment described above.

What is claimed is:

1. An ink jet penetrant comprising a compound represented by general formula (1) obtained by a block polymerization process for sequentially polymerizing an alcohol represented by general formula (2) with propylene oxide and then with ethylene oxide, wherein the penetrant contains the alcohol in an amount of 1% by mass or less:
CₓH₂ₓ₊₁—O—(PO)_{y}-(EO)_{z}—H (1)
(where x denotes an integer of 5 to 10, y an integer of 0 to 7, z an integer of 3 to 10, PO a propylene oxide group, and EO an ethylene oxide group);
CₓH₂ₓ₊₁—OH (2)
(where x denotes an integer of 5 to 10).

2. The ink jet penetrant according to claim 1, wherein the block polymerization process is carried out in the presence of a basic catalyst.

3. An ink composition comprising an ink jet penetrant containing a compound represented by general formula (1) obtained by a block polymerization process for sequentially polymerizing an alcohol represented by general formula (2) with propylene oxide and then with ethylene oxide, wherein the penetrant contains the alcohol in an amount of 0.5% by mass or less:
CₓH₂ₓ₊₁—O—(PO)_{y}-(EO)_{z}—H (1)
(where x denotes an integer of 5 to 10, y an integer of 0 to 7, z an integer of 3 to 10, PO a propylene oxide group, and EO an ethylene oxide group);
CₓH₂ₓ₊₁—OH (2)
(where x denotes an integer of 5 to 10).

4. The ink composition for ink jet recording according to claim 3, wherein the ink jet penetrant is contained in an amount of 0.5% by mass to 5% by mass, both inclusive.

5. The ink composition for ink jet recording according to claim 3, further comprising 0.1% by mass or less of a volatile organic solvent with a normal boiling point of 240° C. or less.

6. The ink composition for ink jet recording according to claim 3, further comprising an anionic surfactant.

7. The ink composition for ink jet recording according to claim 3, wherein the ink composition has a clouding point of 50° C. or more as measured in the absence of any pigment.

8. The ink composition for ink jet recording according to claim 3, wherein the ink composition is used with an ink jet recording apparatus having an ink jet head made of at least one selected from an epoxy adhesive agent, modified polyphenylene ether, and an elastomer.

9. A recording apparatus comprising the ink composition for ink jet recording according to claim 3.

10. A recording apparatus comprising the ink composition for ink jet recording according to claim 4.

11. A recording apparatus comprising the ink composition for ink jet recording according to claim 5.

12. A recording apparatus comprising the ink composition for ink jet recording according to claim 6.

13. A recording apparatus comprising the ink composition for ink jet recording according to claim 7.

14. A recording apparatus comprising the ink composition for ink jet recording according to claim 8.

15. The recording apparatus according to claim 9, wherein the recording apparatus emits less than 5 mg/h of a volatile organic composition (VOC) on a total hourly emission basis.

16. The recording apparatus according to claim 10, wherein the recording apparatus emits less than 5 mg/h of a volatile organic composition (VOC) on a total hourly emission basis.

17. The recording apparatus according to claim 11, wherein the recording apparatus emits less than 5 mg/h of a volatile organic composition (VOC) on a total hourly emission basis.

18. The recording apparatus according to claim 12, wherein the recording apparatus emits less than 5 mg/h of a volatile organic composition (VOC) on a total hourly emission basis.

19. The recording apparatus according to claim 13, wherein the recording apparatus emits less than 5 mg/h of a volatile organic composition (VOC) on a total hourly emission basis.

20. The recording apparatus according to claim 14, wherein the recording apparatus emits less than 5 mg/h of a volatile organic composition (VOC) on a total hourly emission basis.
